(19) United States
(12) Patent Application Publication
(10) Pub. No.: US 2006/0194119 A1
(43) Pub. Date: Aug. 31, 2006

(54) Lithium secondary battery with high performance

(76) Inventors: Mi Young Son, Seoul (KR); Soon Ho Ahn, Daejeon (KR)

Correspondence Address: CANTOR COLBURN, LLP, 55 GRIFFIN ROAD SOUTH, BLOOMFIELD, CT, 06002, US

(21) Appl. No.: 11/361,825

(22) Filed: Feb. 24, 2006

(30) Foreign Application Priority Data
Feb. 25, 2005 (KR) 10-2005-0015885

(51) Int. Cl. H01M 10/40; H01M 4/58

(52) U.S. Cl. 429/337; 429/329; 429/218.1; 429/200; 429/330

(57) ABSTRACT

Disclosed is a lithium secondary battery comprising: (a) a cathode; (b) an anode; (c) a separator; and (d) a non-aqueous electrolyte comprising a lithium salt and an organic solvent, wherein the cathode comprises a cathode active material, doped with at least one element selected from the group consisting of Sn, Al and Zr, or containing the element in the form of a solid solution, and the non-aqueous electrolyte comprises a lithium-containing inorganic salt and a lithium imide salt dissociated in at least one organic solvent including gamma-butyrolactone (GBL). The lithium secondary battery can minimize side reactions between both electrodes and gamma-butyrolactone (GBL), used as a conventional electrolyte for a battery, and thus can provide high capacity, long service life and improved quality at high-temperature.

This application claims the benefit of the filing date of Korean Patent Application No. 10-2005-0015885, filed on 25 Feb. 2005, in the Korean Intellectual Property Office, the disclosure of which is incorporated herein in its entirely by reference.

### TECHNICAL FIELD

The present invention relates to a lithium secondary battery, which shows improved quality due to the minimization of redox side reactions between gamma-butyrolactone (GBL) used as an electrolyte for a battery and both electrodes.

### BACKGROUND ART

Recently, as portable electronic appliances, such as portable phones, camcorders or notebook PCs, have become increasingly in demand, batteries have been spotlighted as power sources for such appliances. Accordingly, many attempts have been made to develop a battery having a light weight and showing a high voltage, high capacity and high output, in particular, a lithium secondary battery using a non-aqueous electrolyte, as a drive source for such portable electronic appliances. It is required to consider the safety of the battery having a high voltage, high capacity, high output and long service life, in addition to the quality of the battery.

In general, a lithium secondary battery includes a lithium-containing transition metal oxide as a cathode active material, and carbon, lithium metal or alloys, or other metal oxides (e.g. TiO₂ or SnO₂) capable of lithium intercalation/deintercalation and having an electric potential based on lithium of less than 2V, as an anode active material. Lithium secondary batteries may be classified into LiLBs (lithium ion batteries), LiPBs (lithium ion polymer batteries) and LPBs (lithium polymer batteries), depending on the type of the electrolyte used therein. More particularly, LiLBs use a liquid electrolyte, LiPBs use a gel type polymer electrolyte, and LPBs use a solid polymer electrolyte.

Although various non-aqueous solvents may be used as an electrolyte for such batteries, it is preferable to use high-boiling point solvents such as cyclic carbonates, including ethylene carbonate (EC), propylene carbonate (PC), or gamma-butyrolactone (γ-butyrolactone; GBL). However, among these high-boiling point solvents, a mixed solvent containing EC and PC shows high viscosity. Hence, when the mixed solvent is used as an electrolyte for a battery, a separator shows poor wettability with the electrolyte and low ion conductivity, resulting in degradation in the quality of the battery. Under these circumstances, it has been suggested to use a mixed solvent containing GBL and EC showing a relatively low viscosity among the aforementioned high-boiling point solvents.

GBL has a low viscosity and a low melting point, and thus shows high ion conductivity and permits a large amount of electric current to flow therethrough. Particularly, GBL has excellent ion conductivity compared to other high-boiling point solvents even at a low temperature as low as about −30° C. Additionally, GBL shows a high dielectric constant and allows an electrolyte salt to be dissolved therein to a high concentration. However, when using GBL as an electrolyte for a battery, GBL may cause a reductive decomposition reaction with an anode active material, resulting in degradation in the quality and cycle characteristics of the battery. Particularly, when such batteries using GBL as an electrolyte are stored at high temperature, there is significant degradation in the quality of the batteries. It is thought that this is because GBL oxide formed on a cathode increases electric resistance in the cathode.

### BRIEF DESCRIPTION OF THE DRAWINGS

The foregoing and other objects, features and advantages of the present invention will become more apparent from the following detailed description when taken in conjunction with the accompanying drawing in which:

FIG. 1 is an EIS (Electrochemical Impedance Spectroscopy) graph for the cathode obtained from the cathode active material doped with Sn according to Example 1 and for the cathode obtained by using a conventional method according to Comparative Example 1.

### DISCLOSURE OF THE INVENTION

The present inventors have recognized that use of GBL as an electrolyte solvent for a battery results in degradation in the quality of the battery, including the capacity, cycle characteristics and high-temperature storage characteristics of the battery, and have performed research and studies to inhibit side reactions between GBL and both electrodes. Then, the present inventors have found that when a lithium imide salt is added to an electrolyte, and a cathode active material is doped with an element capable of imparting structural stability thereto or further comprises the same element present in the form of a solid solution, it is possible to prevent degradation in the quality and the cycle characteristics of the battery, caused by a reductive decomposition reaction between GBL and an anode, and to solve the problem of degradation in the quality of the battery at high temperature, caused by oxidation of GBL in a cathode.

Therefore, an object of the present invention is provided a lithium secondary battery having improved overall characteristics, including capacity, service life, and high-temperature storage characteristics.

In order to accomplish the above object, according to one aspect of the present invention, there is provided a lithium secondary battery comprising: (a) a cathode; (b) an anode; (c) a separator; and (d) a non-aqueous electrolyte comprising a lithium salt and an organic solvent, wherein the cathode comprises a cathode active material doped with at least one element selected from the group consisting of Sn, Al and Zr, or containing the element in the form of a solid solution, and the non-aqueous electrolyte comprises a lithium-containing inorganic salt and a lithium imide salt, dissociated in at least one organic solvent including gamma-butyrolactone (GBL).

Hereinafter, the present invention will be explained in more detail.

The present invention is characterized in that components for inhibiting side reactions between GBL and both electrodes, and degradation in the quality of a battery using GBL as a main electrolyte solvent, caused by such side reactions, are used in an electrolyte and a cathode, wherein the components include a lithium imide salt, and a cathode active material, doped with at least one element selected from the group consisting of tin (Sn), aluminum (Al) and zirconium (Zr), or further comprising the same element in the form of a solid solution.

In general, when GBL, having a high boiling point and a relatively low viscosity, is used in an electrolyte for a battery as a single component or one of the components forming the electrolyte, side reactions may occur between GBL and both electrodes. That is, GBL causes an oxidation reaction and a reduction reaction at a cathode and an anode, respectively. Hence, electric resistance increases in the cathode due to the GBL oxide formed in the cathode, and the battery experiences degradation in the capacity and the cycle characteristics due to the reductive decomposition between the anode active material and GBL.

(1) First, according to the present invention, use of a lithium imide salt combined with a lithium fluoride currently used as a lithium salt can prevent degradation in the quality of a battery, caused by the reductive decomposition between an anode active material and GBL.

Quality of a battery mainly depends on the constitutional elements of an electrolyte and a solid electrode interface (SEI), formed via the reaction between the electrolyte and an electrode.

In a lithium secondary battery, during the first charge cycle, carbon particles, used as an anode active material, react with an electrolyte on the surface of the anode to form a solid electrolyte interface (SEI) film. The SEI film formed as described above serves to inhibit side reactions between carbonaceous materials and an electrolyte solvent and structural collapse of an anode material, caused by co-intercalation of an electrolyte solvent into the anode active material, and functions sufficiently as a lithium ion tunnel, thereby minimizing degradation in the quality of a battery. However, SEI films formed by a conventional carbonate-based organic solvent, fluorine-containing salts or other inorganic salts are week, porous and coarse so that lithium ion conduction cannot be made smoothly. Thus, under these circumstances, the amount of reversible lithium decreases and irreversible reactions increase during repeated charge/discharge cycles, resulting in degradation in the capacity and lifespan characteristics of a battery.

Particularly, the problem of a drop in the initial capacity is serious when a carbonaceous material such as graphite is used as an anode active material and GBL containing LiBF₄ dissolved therein is used as an electrolyte. It is thought that this is because irreversible reactions accompanied with consumption of a great amount of lithium ions occur excessively upon the formation of a film on the anode surface during the first charge cycle, resulting in degradation in the initial capacity of a battery. Additionally, when GBL used as an electrolyte solvent participates in the formation of the SEI film, electrochemical properties of a carbonaceous material, used as the anode active material (for example, graphite), tend to depend significantly on an electrolyte salt. When GBL is used along with an electrolyte salt such as LiPF₆ or LiClO₄, the anode causes rapid degradation in terms of the cycle life characteristics.

According to the present invention, an organic lithium salt having increased resistance to decomposition compared to a conventional carbonate solvent and lithium fluoride, i.e. a lithium imide salt is used as the lithium salt for an electrolyte in a predetermined amount. Use of the organic lithium salt results in the formation of a firm and dense imide-containing organic SEI film, which is favorable in terms of the consumption and regeneratability of SEI (solid electrode interface) compared to a conventional inorganic SEI film, on the surface of the anode active material during the first charge cycle. Therefore, it is possible to improve the lifespan characteristics of a battery by reducing the reactivity between an electrolyte and an electrode.

Additionally, an SEI film is formed by consuming reversible lithium ions. Here, consumption of lithium ions depends on the amount of lithium contained in the materials produced via the reduction of the main electrolyte solvent at the anode and on the kind of the electrolyte salt used along with the solvent. According to the present invention, an organic electrolyte salt is used instead of a fluorine-containing electrolyte salt or inorganic electrolyte salt that form an SEI film by consuming a great amount of lithium ions. Therefore, the SEI film formed upon the initial formation state of a battery is converted into an organic SEI film according to the present invention, and thus it is possible to control the irreversible reactions requiring lithium consumption during repeated charge/discharge cycles. As a result, it is possible to minimize degradation in the quality of a battery by virtue of the decreased lithium consumption.

(2) Next, according to the present invention, a cathode active material, doped with an element capable of imparting structural stability thereto (e.g. Sn, Al, Zr or a combination thereof), or comprising the same element in the form of a solid solution, is used. Hence, it is possible to prevent degradation in the quality of a battery at high temperature, caused by an oxidative decomposition reaction between a cathode active material and GBL.

In a lithium secondary battery, high-temperature storage characteristic is one of the essential characteristics for the battery. GBL shows a drop in the oxidation potential, when a battery using GBL is stored at high temperature. Due to the unique property, GBL oxide is formed at a cathode, resulting in an increase in the electric resistance in the cathode and degradation in the quality of a battery. Additionally, the GBL oxide is reduced at an anode to form other byproducts, resulting in significant degradation in the quality of a battery.

Therefore, according to the present invention, a cathode active material doped with an element capable of imparting structural stability thereto (e.g. Sn, Al, Zr or a combination thereof), or comprising the element in the form of a solid solution, is used. The cathode active material shows a decreased oxidation potential, and thus it is possible to inhibit oxidation of the highly reactive GBL electrolyte at the cathode and side reactions between GBL and a cathode active material, unstabilized in a fully charged state under high-temperature storage conditions, and to decrease the electric resistance at the cathode. Because GBL oxide formation is inhibited fundamentally as described above, reduction of GBL oxide at the anode, followed by formation of other byproducts, is also prevented fundamentally. Additionally, a product obtained from the lithium imide salt via a decomposition reaction at the cathode may serve as a protective film capable of masking the active site of the cathode surface. Therefore, it is possible to prevent dissolution of a part of transition metals and precipitation thereof on the anode during repeated charge/discharge cycles. Also, it is possible to inhibit side reactions between GBL and the cathode and gas generation caused by such side reactions, and thus to prevent degradation in the lifespan characteristics of a battery under high temperature, by virtue of smooth lithium intercalation/deintercalation.

(3) Combination of the aforementioned lithium imide salt with the cathode active material, doped with an element selected from the group consisting of Sn, Al, Zr and combinations thereof, or comprising the element in the form of a solid solution, can provide synergy derived from stable protective films formed in both electrodes during repeated charge/discharge cycles, and thus can improve the overall quality of a battery.

Herein, there is no particular limitation in the shape, size and composition of the cathode active material according to the present invention, as long as it comprises an active material capable of lithium intercalation/deintercalation (e.g. a lithium transition metal composite oxide and/or a chalcogenide compound), which is doped with an element selected from the group consisting of Sn, Al, Zr and combinations thereof, or comprises the same element in the form of a solid solution.

The aforementioned element, Sn, Al or Zr permits easy doping to an electrode active material, and thus contributes to increase the structural stability of an electrode during repeated lithium intercalation. Particularly, Sn may substitute for the transition metal in the electrode active material even with a small amount. For example, Sn may substitute for Co in LiCoO₂, thereby improving the structural stability of the electrode active material. Preferred examples of the cathode active material comprising the aforementioned element include, but are not limited to: LiCoO₂•zLiMO₃ (wherein M=Sn, Al or Ar; and 0.00≦z≦0.03).

The cathode active material based on a lithium-containing metal composite oxide is a lithium-containing metal oxide comprising at least one element selected from the group consisting of alkali metals, alkaline earth metals, Group 13 elements, Group 14 elements, Group 15 elements, transition metals and rare earth elements. Non-limiting examples of the cathode active material include composite oxides, such as lithium manganese oxides (e.g. LiMn₂O₄), lithium cobalt oxides (e.g. LiCoO₂), lithium nickel oxides (e.g. LiNiO₂), lithium iron oxides (e.g. LiFeO₄), or combinations thereof. Particular examples of such composite oxides include LiCoO₂, LiNiO₂, LiMn₂O_{4,} LiMnO₂, LiNi_{1-X}Co_{X}M_{Y}O₂ (wherein M=Al, Ti, Mg or Zr, 0<X≦, and 0≦Y≦0.2), LiNi_{X}Co_{Y}Mn_{1-X-Y}O₂ (wherein 0<X≦0.5, and 0<Y≦0.5), LiM_{X}M′_{y}Mn_{(2-x-y)}O₄ (wherein each of M and M′=V, Cr, Fe, Co, Ni or Cu, 0<X≦1, and 0<Y≦1), or the like. Additionally, non-limiting examples of the cathode active material based on a chalcogenide compound include TiS₂, SeO₂, MOS₂, FeS₂, MnO₂, NbSe₃, V₂O₅, V₆O₁₃, CuCl₂ or mixtures thereof.

Herein, there is no particular limitation in the content of the element, such as Sn, Al or Zr, contained in the cathode active material, and the content can be controlled in such a range as to improve the quality of a battery.

The cathode active material, doped with the element selected from the group consisting of Sn, Al and Zr, may be prepared by a conventional method known to one skilled in the art, preferably a solid phase reaction method. One embodiment of the method will be explained hereinafter.

(1) First, a cobalt precursor compound, a lithium precursor compound, and a compound containing Sn, Al, Zr or a combination thereof are mixed in a desired equivalent ratio.

Herein, each precursor compound that may be used in the present invention is a water soluble or insoluble compound comprising the aforementioned element and capable of ionization, and particular non-limiting examples thereof include alkoxide, nitrate, acetate, halide, hydroxide, oxide, carbonate, oxalate, sulfate, phosphate or a combination thereof, containing each element.

More particularly, examples of the cobalt precursor compound that may be used in the present invention include cobalt hydroxide, cobalt nitrate, cobalt oxide, cobalt carbonate, cobalt acetate, cobalt oxalate, cobalt sulfate, cobalt chloride, or the like. Additionally, particular examples of the lithium-containing water soluble compound include lithium nitrate, lithium acetate, lithium hydroxide, lithium carbonate, lithium oxide, lithium sulfate, lithium chloride, or the like. Further, particular examples of the water soluble or insoluble compound containing tin, aluminum, zirconium or a combination thereof include tin-containing hydroxide, nitrate, acetate, chloride, carbonate, oxide, sulfate, or the like.

It is preferable that Co₃O₄, Li₂CO₃ and SnO₂ are used as the cobalt precursor compound, the lithium precursor compound and the precursor compound containing Sn, Al or Zr, respectively. Also, Al₂O₃ and ZrO₂ may be used. Other conventional additives may also be used.

The above compounds are mixed by a method generally known to one skilled in the art. For example, the cobalt precursor compound, the lithium precursor compound and the Sn- , Al- or Zr-containing precursor compound are mixed by way of mortar grinder mixing in a desired equivalent ratio to provide a mixture.

There is no particular limitation in the equivalent ratio of the cobalt precursor compound, the lithium precursor compound and the Sn-, Al- or Zr-containing precursor compound, and the ratio can be controlled in a range currently used in the art.

Herein, a dry mixing process and a wet mixing process may be used. The dry mixing process uses no solvent, and the wet mixing process uses an adequate solvent, such as ethanol, methanol, water or acetone, in order to accelerate the reaction occurring in the mixture of the cobalt precursor compound, the lithium precursor compound and the Sn-, Al- or Zr-containing precursor compound. In the wet mixing process, the reaction mixture is mixed substantially to a solvent-free state. Although both processes may be used, the wet mixing process is preferred. The mixture obtained as described above may be optionally palletized before it is subjected to heat treatment.

(2) Then, the mixture is subjected to heat treatment at a temperature of 700˜900° C. for 4˜24 hours.

The heat treatment is carried out under dry air or oxygen at a heating/cooling rate of 0.5˜10° C./min, wherein the mixture is maintained at each heat treatment temperature for a predetermined time. Next, the heat treated powder is pulverized by way of mortar grinding.

According to the present invention, the cathode and the anode may be obtained by a method generally known to one skilled in the art. In one embodiment of the method, the anode active material or the cathode active material, prepared according to the present invention, is mixed with a binder, a dispersion medium, or the like, and then a small amount of a conductive agent or a viscosity adjusting agent is optionally added thereto to provide electrode slurry. Next, each electrode slurry is coated onto each current collector, followed by rolling and drying.

Non-limiting examples of the anode active material that may be used in the present invention include carbonaceous materials, lithium metal or alloys thereof, which is capable of lithium ion intercalation/deintercalation, or other metal oxides capable of lithium intercalation/deintercalation and having a potential based on lithium of less than 2V (e.g. TiO₂, SnO₂ and Li₄Ti₅O₁₂).

There is no particular limitation in the conductive agent as long as it undergoes no chemical change in a battery. Non-limiting examples of the conductive agent include carbon black such as acetylene black, ketjen black, furnace black or thermal black; natural graphite, artificial graphite, conductive carbon fiber, or the like. Among these, carbon black, graphite powder and carbon fibers are preferred.

The binder may be any one resin selected from the group consisting of thermoplastic resins, thermosetting resins and combinations thereof. Among these resins, polyvinylidene fluoride (PVdF) or polytetrafluoro ethylene (PTFE) is preferred, with PVdF being most preferred.

As the dispersion medium, a water-based medium or an organic dispersion medium such as N-methyl-2-pyrrolidone may be used.

The lithium secondary battery may be manufactured by providing an electrode assembly comprising a cathode, an anode and a separator interposed between both electrodes, and by injecting an electrolyte containing a lithium-containing inorganic salt and a lithium imide salts, dissociated in at least one organic solvent including gamma-butyrolactone (GBL).

The electrolyte that may be used in the present invention comprises electrolyte salts including a lithium-containing inorganic salt and a lithium imide salt, and an organic solvent including GBL.

There is no particular limitation in the lithium imide salt, as long as it is a lithium-containing compound having an imide group. Particularly, LiBETI (Li bisperfluoroethanesulfonimide, LiN(C₂F₅SO₂)₂), LiTFSI (lithium (bis)trifluoromethanesulfonimide, LiN(CF₃SO₂)₂) or a mixture thereof is preferred.

Herein, the lithium-containing inorganic salt is at least one salt selected from the group consisting of LiClO_{b 4}, LiCF₃SO₃, LiPF₆, LiBF₄, LiAsF₆, LiSbF₆, LiSCN and LiN(CF₃SO₂)₂. Among these salts, lithium fluoride is preferred and LiBF4 is more preferred.

Additionally, the organic solvent essentially comprises gamma-butyrolactone (GBL) and may further comprise propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethylmethyl carbonate (EMC), fluoroethylene carbonate (FEC), methyl formate, ethyl formate, propyl formate, methyl acetate, ethyl acetate, propyl acetate, pentyl acetate, methyl propionate, ethyl propionate, propyl propionate, butyl propionate or a mixture thereof. Among these solvents, a mixed solvent of ethylene carbonate with gamma-butyrolactone, having a high boiling point, is preferred. Preferably, the mixed solvent has a mixing ratio of EC:GBL=10˜50:50˜90 (volume %), but is not limited thereto.

Although there is no particular limitation in the total concentration of the lithium salts, the lithium salts are preferably used in a total concentration of 1˜1.5 M. If the lithium salts are used in a total concentration of less than 1 M, ion conductivity decreases and the quality of a battery (e.g. C-rate characteristic) may be degraded. If the lithium salts are used in a total concentration of greater than 1.5 M, the electrolyte becomes have an increased viscosity, and gas generation under high temperature storage conditions increases. Preferably, the mixing ratio of the lithium salts (lithium-containing inorganic salt: lithium imide salt) is 0.5˜1.45 (M): 0.05˜1.0 (M), but is not limited thereto. If the lithium imide salt is used in a concentration of greater than 1.0 M, corrosion of aluminum foil, used as a cathode collector, may occur due to the corrosive anions present in the electrolyte.

Although there is no particular limitation in the separator that may be used in the present invention, porous separators are widely used. Particular examples of the porous separators include polypropylene-based separators, polyethylene-based separators and polyolefin-based separators. Additionally, porous separators containing inorganic particles introduced thereto may be used.

There is no particular limitation in the outer shape of the lithium secondary battery obtained by the method according to the present invention. The lithium secondary battery may be a cylindrical battery using a can, a prismatic battery, a pouch type battery or a coin type battery.

### BEST MODE FOR CARRYING OUT THE INVENTION

Reference will now be made in detail to the preferred embodiments of the present invention. It is to be understood that the following examples are illustrative only and the present invention is not limited ‘hereto.

### EXAMPLES 1˜2

### Example 1

(Manufacture of Anode)

First, 94 wt % of artificial graphite as an anode active material, 1 wt% of a conductive agent and 5 wt % of PVDF (binder) were added to NMP (N-methyl-2-pyrrolidone) as a solvent to form anode slurry. Then the slurry is coated onto a copper collector to provide an anode.

(Manufacture of Cathode)

First, 94 wt % of LiCoO₂•zLiSnO₃ (0.00<z≦0.03), 3 wt % of a conductive agent and 3 wt % of PVDF (binder) were added to NMP as a solvent to form cathode slurry. Then, the slurry is coated onto an aluminum collector to provide a cathode.

(Preparation of Electrolyte)

To an electrolyte containing EC and GBL in a ratio of 2:3 (EC:GBL), LiBF₄ and LiBETI (LiN(C₂F₅SO₂)₂) were added to a total lithium salt concentration of 1.5 M, wherein LiBF₄ and LiBETI (LiN(C₂F₅SO₂)₂) were used in a ratio of 1 M:0.5 M.

(Manufacture of Battery)

A porous separator was interposed between the cathode and the anode obtained as described above to form an electrode assembly, and then the electrolyte was injected into the electrode assembly to provide a full cell.

### Example 2

Example 1 was repeated to form a lithium secondary battery, except that the lithium salts contained the electrolyte were used in a ratio of 0.5 M:1.0 M (LiBF₄:LiBETI).

### COMPARATIVE EXAMPLE 1˜2

### Comparative Example 1

Example 1 was repeated to provide a lithium secondary battery, except that LiBETI was not used but lithium fluoride (LiBF₄) was used alone in a concentration of 1.5 M, and LiCoO₂ was used as a cathode active material.

### Comparative Example 2

Example 1 was repeated to provide a lithium secondary battery, except that LiCoO₂ was used as a cathode active material.

### Experimental Example 1. Evaluation for Quality of Lithium Secondary Batteries

1-1. Evaluation for Charge/Discharge Capacity

The following experiment was performed to evaluate the quality of the batteries according to Example 1, Example 2 and Comparative Example 1.

To each battery, constant current was applied at a rate of 0.2 C in a CC-CV (constant current-constant voltage) manner to 4.2V, and the current was controlled at 4.2V in a constant voltage manner. Meanwhile, each battery was discharged at a rate of 0.2 C in a CC (constant current) manner to a cut-off voltage of 3.0 V, and the discharge capacity was shown in the following Table 1.

As shown in Table 1, when two different kinds of salts are used in the electrolyte, an SEI film formed upon the initial formation state has a different composition, resulting in a change in the consumption of Li during repeated charge/discharge cycles, followed by a change in the capacity. Particularly, as the amount of a lithium imide salt (LiBETI) increases, initial charge capacity and discharge capacity increase, resulting in an increase in the discharge capacity relative to the charge capacity. Therefore, it is possible to obtain an increased capacity (see Table. 1).

TABLE 1

| | Total electrolyte | | Discharge |
|---|---|---|---|
| | salt concentration | Charge capacity | Capacity |
| Battery | (1.5M) | (mAh/g) | (mAh/g) |
| Ex. 1 | LiBF₄ (1M) + LiBETI | 779 | 748 |
| | (0.5M) | | |
| Ex. 2 | LiBF₄ (0.5M) + LiBETI | 796 | 765 |
| | (1M) | | |
| Comp. Ex. 1 | LiBF₄ (1.5M) | 773 | 744 |

1-2. Evaluation for Cycle Life Characteristics

The following experiment was carried out to evaluate the cycle characteristics of the batteries according to Example 1 and Comparative Example 1.

To each battery, constant current was applied at a rate of 0.2 C in a CC-CV (constant current-constant voltage) manner to 4.2V, and the current was controlled at 4.2V in a constant voltage manner. Meanwhile, each battery was discharged at a rate of 1.0 C in a CC (constant current) manner to a cut-off voltage of 3.0V, and the cycle life characteristics were shown in the following Table 1 in terms of a percent ratio based on the initial capacity.

After the experiment, it can be seen that the lithium secondary battery containing the electrolyte, to which LiBETI is added, according to Example 1 shows significantly improved cycle life characteristics (see Table. 2). It is thought that this is because LiBETI participates in the consumption and regeneration of the SEI film, and the SEI film containing the organic component reduces side reactions between the electrolyte and an electrode, resulting in improvement of the cycle life characteristics.

TABLE 2

| Capacity ratio (%) based | Comp. Ex. 1 | Ex. 1 |
|---|---|---|
| on initial capacity | LiBF₄ (1.5M) | LiBF₄ (1M) + LiBETI (0.5M) |
| 1 cycle | 100.0 | 100.0 |
| 100 cycles | 97.2 | 95.9 |
| 200 cycles | 90.3 | 91.1 |
| 300 cycles | 74.1 | 81.9 |
| 400 cycles | 39.1 | 61.7 |

Experimental Example 2. Evaluation for High-Temperature Storage Characteristics of Lithium Secondary Battery

The following experiment was performed to evaluate the high-temperature storage characteristics of the lithium secondary batteries according to Example 1 and Comparative example 1.

After determining the initial capacity of each battery, each battery was measured by EIS (electrochemical impedance spectroscopy). Next, each battery was stored at 90° C. for 4 hours, and then was measured again by EIS at room temperature to determine variations in the cathode resistance after the high-temperature storage.

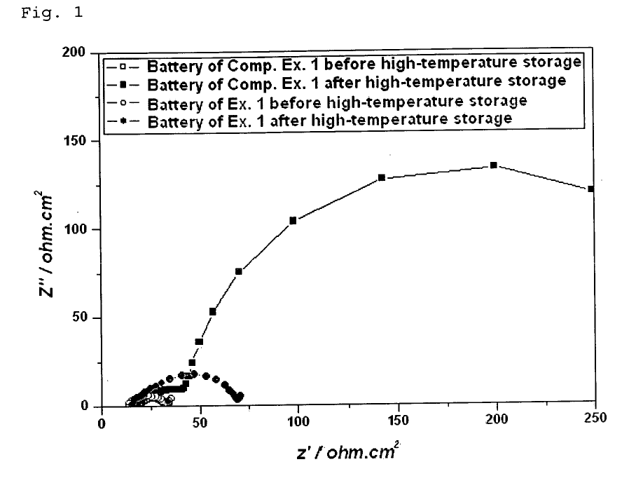

After the experiment, it can be seen that the battery using a conventional cathode according to Comparative Example 1 shows a significant increase in the cathode resistance after the high-temperature storage, while the battery using the cathode doped with Sn according to Example 1 shows a significant drop in the cathode resistance (see FIG. 1). This indicates that Sn doped onto the cathode active material reduces side reactions between the unstable cathode active material and the electrolyte, resulting in a significant drop in the cathode resistance.

Industrial Applicability

As can be seen from the foregoing, according to the present invention, use of a cathode active material comprising at least one element selected from the group consisting of Sn, Al and Zr reduces reactivity of a cathode with GBL, and the imide salt used as an electrolyte salt along with a lithium-containing salt forms a stable and firm SEI film on an anode. Therefore, it is possible to minimize reactivity of both electrodes with GBL, and thus to improve the quality of a battery.

While this invention has been described in connection with what is presently considered to be the most practical and preferred embodiment, it is to be understood that the invention is not limited to the disclosed embodiment and the drawings. On the contrary, it is intended to cover various modifications and variations within the spirit and scope of the appended claims.

1. A lithium secondary battery comprising:
(a) a cathode;
(b) an anode;
(c) a separator; and
(d) a non-aqueous electrolyte comprising a lithium salt and an organic solvent,
wherein the cathode comprises a cathode active material, doped with at least one element selected from the group consisting of Sn, Al and Zr, or containing the element in the form of a solid solution, and the non-aqueous electrolyte comprises a lithium-containing inorganic salt and a lithium imide salt, dissociated in at least one organic solvent including gamma-butyrolactone (GBL).

2. The lithium secondary battery as claimed in claim 1, wherein the cathode active material, doped with at least one element selected from the group consisting of Sn, Al and Zr, or containing the element in the form of a solid solution is LiCoO₂•zLiMO₃ (wherein M=Sn, Al or Zr; and 0.00≦z≦0.03).

3. The lithium secondary battery as claimed in claim 1, wherein the lithium imide salt is at least one salt selected from the group consisting of LiBETI (lithium bisperfluoroethanesulfonimide, LiN(C₂F₅SO₂)₂), and LiTFSI (lithium (bis)trifluoromethanesulfonimide, LiN(CF₃SO₂)₂)

4. The lithium secondary battery as claimed in claim 1, wherein the lithium-containing inorganic salt is at least one salt selected from the group consisting of LiClO₄, LiBF₄, LiPF₆, LiAsF₆, LiSCN and LiSbF₆.

5. The lithium secondary battery as claimed in claim 1, wherein the lithium-containing inorganic salt is lithium fluoride.

6. The lithium secondary battery as claimed in claim 1, wherein the organic solvent is at least one solvent selected from the group consisting of propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethylmethyl carbonate (EMC), fluoroethylene carbonate (FEC), methyl formate, ethyl formate, propyl formate, methyl acetate, ethyl acetate, propyl acetate, pentyl acetate, methyl propionate, ethyl propionate, propyl propionate, and butyl propionate.

7. The lithium secondary battery as claimed in claim 1, wherein the organic solvent is a mixed solvent of ethylene carbonate (EC) with gamma-butyrolactone (GBL).

8. The lithium secondary battery as claimed in claim 1, wherein the lithium salts are present in a total concentration of 1˜1.5M.

9. The lithium secondary battery as claimed in claim 1, wherein the lithium-containing inorganic salt and the lithium imide salt are used in a molar (M) ratio of 0.5˜1.45 (M): 0.05˜1.0 (M)
